(19) United States
(12) Patent Application Publication
(10) Pub. No.: US 2018/0065873 A1
(43) Pub. Date: Mar. 8, 2018

(54) PROCESSES FOR TREATING SELENATE IN WATER

(71) Applicant: WELLTODO LTD., M.P. Menashe (IL)

(72) Inventors: Uri MEYTAL, Haifa (IL); Hovav GlLAN, Kadima (IL)

(21) Appl. No.: 15/563,789

(22) PCT Filed: Mar. 28, 2016
(86) PCT No.: PCT/IL2016/050333

§ 371 Date: Oct. 2, 2017

Related U.S. Application Data
(60) Provisional application No. 62/142,175, filed on Apr. 2, 2015.

(51) Int. Cl. C02F 1/70; B01J 23/89

(52) U.S. Cl. CPC C02F 1/705; C02F 2101/106; B01J 23/8906

(57) ABSTRACT

A process and a bimetallic catalyst comprising, supported on a carrier, a combination of Pd and Fe species, are provided for converting selenate to selenite in water.

### TECHNOLOGICAL FIELD

The present disclosure concerns a process for reducing level of dissolved selenium species in water.

### BACKGROUND ART

Reference considered to be relevant as background to the presently disclosed subject matter are listed below:

[1] Golder Associates Inc. Literature Review of Treatment Technologies to Remove Selenium from Mining Influenced Water, Teck Coal Limited, Calgary, pages AB 0842-0034 p. 1-28 and Tables (2009).

Acknowledgement of the above reference herein is not to be inferred as meaning that this is in any way relevant to the patentability of the presently disclosed subject matter.

### BACKGROUND

One of the toxic species in water is dissolved selenium which is present in the water as its soluble forms, selenate SeO₄²⁻ (Se^{VI}) and selenite SeO₃²⁻ (Se^{IV}). Among available treatment processes, these selenium species can be removed from water by chemical reduction by zero valent iron (ZVI), known as the ZVI process [1]. As also described, ferrous cations can also reduce selenate to selenite and subsequently remove selenite by adsorption to iron hydroxides. In an aqueous environment, ZVI can be oxidized to ferric (Fe³⁺) and ferrous (Fe²⁺) ions. These ions react with hydroxyl ions present in water to form ferric and ferrous hydroxides. Selenate is reduced to selenite while ferrous iron is oxidized to ferric iron. Selenite then adsorbs to the ferric and ferrous hydroxide surfaces and is removed from solution.

### GENERAL DESCRIPTION

The present disclosure is based on the development of a catalyst with high activity in reducing selenate to selenite.

Thus, in accordance with a first of its aspects, the present disclosure provides a process for converting selenate to selenite, the process comprises contacting water containing selenate, under hydrogen environment, with a bimetallic catalyst comprising, supported on a carrier, a combination of Pd and Fe species, wherein said contacting with the bimetallic catalyst results in the reduction of selenate to selenite.

In accordance with a second aspect, there is provided herein a process for treating water, the process comprises converting selenate to selenite as disclosed herein to obtain selenite containing water; contacting the selenite containing water with a second catalyst capable of reducing selenite to selenium; and removing said selenium from the water.

In accordance with a third aspect there is provided herein a bimetallic catalyst comprising, supported on a carrier, a combination of Pd with and Fe species. The bimetallic catalyst is for use in a process for converting selenate in water to selenite and/or for use in a process for treating water.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 provides a schematic diagram of a system for testing the catalysts samples disclosed herein, in accordance with one embodiment.

FIG. 2 is a graph showing the normalized activity of some tested samples in reducing level of selenate in water.

### DETAILED DESCRIPTION OF EMBODIMENTS

The present disclosure is based on the finding that the combination of two metal entities, palladium (Pd) and iron (Fe) species has high activity in reducing, in water, of selenate to selenite.

Specifically, it has been found that the combination of 1% wt Pd and 1% wt Fe, or 1.29% wt FeₓO_{y,} being supported on an activated carbon fibrous fabric (ACFF), was effective in reducing selenate to selenite with an activity being ten times greater than 1% Pd supported on ACFF, and even more than 10 times greater when compared to the activity of the combination of 1% Pd 0.36% Cu 1% Fe supported on ACFF.

Thus, the present disclosure provides, in accordance with a first of its aspects, a process for converting selenate to selenite, the process comprises contacting water containing selenate, under hydrogen environment, with a bimetallic catalyst comprising, supported on a carrier, a combination of Pd and Fe species, wherein said contacting with the bimetallic catalyst results in the reduction of selenate (SeO₄²⁻) to selenite (SeO₃²⁻).

In this connection, it is noted that in the absence of the bimetallic catalyst the spontaneous rate of conversion to selenite is very low and requires high energy, and thus, not feasible without a suitable catalyst.

The contacting between the bimetallic catalyst and the water is under hydrogen environment. In the context of the present disclosure, the term “under hydrogen environment” is to be understood to mean water containing hydrogen, dissolved or otherwise distributed within the water, to allow the participation of the hydrogen in the conversion of selenate to selenite. Without being bound by theory, in the presence of hydrogen, participating as a reducing agent, selenate dissolved in the water is converted to selenite by hydrogenation in the following reaction:

SeO₄²⁻+H₂→SeO₃²⁻+H₂O (A)

The introduction of hydrogen into the water is typically under pressure. In some embodiments the pressure is between 4 to 10 bar. There are various techniques for introducing hydrogen into water in order to achieve the hydrogen environment, for example, using a diffuser, venturi ejector pump, mixing, bubbling of the gas, air jets, and/or multiphase pump. In some examples, the introduction of the hydrogen is for obtaining hydrogen essentially evenly distributed in the water. In some other examples, the introduction of hydrogen is by dissolving the same in water. The presence of excess of hydrogen is to allow it to participate as a reducing agent in the conversion reaction of selenate to selenite.

The conversion reaction is catalyzed by the bimetallic catalyst containing Pd (elemental metallic) in combination with Fe species. The combination of these two entities is referred to herein, at times, as the catalytic entities or catalytic parties.

When referring to Fe species it is to be understood to include any one or combination of metallic iron (Fe) and iron oxide.

When referring to iron oxide, it is to be understood to refer to any form of iron oxide, such as, and without being limited thereto, compounds having the general formula FeₙOₘ with n being an integer from 1 to 3 and m being an integer from 1 to 4.

In some examples, the iron species is an iron oxide selected from the group consisting of FeO, Fe₂O₃ (hematite), Fe₃O₄ (magnetite) and mixtures thereof.

In some examples, the iron species is an iron oxide having the general formula Feₙ(O)ₘ with n being an integer of 2 or 3 and m being an integer of 3 or 4.

In yet some further examples, the iron species is an iron oxide selected from the group consisting of FeO and Fe₂O₃.

In yet one further example, the iron species is selected from FeO, Fe₂O₃ and mixtures thereof.

In yet some further example, the iron species is FeO.

In yet some further example, the iron species is Fe₂O₃.

In some examples, the iron species is metallic (elemental) Fe.

In some examples, the Fe species encompass a combination of iron oxide and/or iron oxide(s) with elemental Fe. The combination of Fe species in the bimetallic catalyst may vary and can be defined by mass % wt of each form with respect to the total % wt of the Fe species in the catalyst.

In some examples, the bimetallic catalyst comprises at least 70% wt of: Fe₂O₃, FeO or mixtures thereof, out of the total iron oxides in the catalyst, at times, at least 75%, at least 80%, at least 85%, at least 90%, at least 95%, at least 99% of Fe₂O₃ or FeO out of the total iron oxide in the catalyst. In some examples, the iron species consist essentially of FeO and/or Fe₂O₃.

In some preferred examples, the catalytic entity in the bimetallic catalyst consists of only the combination of Pd and the Fe species. In other words, while the catalyst may carry other substances, the catalytic activity is performed solely by the presence of the combination of Pd and Fe species. In some further preferred examples, the catalytic entity consists of Pd and Fe species in a mass ratio of about 1:1.

In general, the activity of the catalyst can depend on, inter alia, the ratio between the two metal parties, their loading onto the carrier, the surface coverage of the carrier, surface area ratio between the two metal parties, size and shape of carrier, etc.

The carrier can carry the Pd and Fe species in varying % wt ratios (% weight percent denoting the % of weight (mass) of the substance out of the total weight (mass) of the catalyst). There are various techniques available to determine the weight of each, as known to those versed in the art.

In some examples, the % wt ratio between the catalytic entities, namely, said Pd and said Fe (either when in the form of elemental Fe or an oxide) is between 1:0.2 to 1:3; at times, between 1:0.2 to 1:1.8; at times, between 1:0.3 to 1:1.7; at times, between 1:0.4 to 1:1.6; at times, between 1:0.5 to 1:1.5; at times, between 1:0.6 to 1:1.4; at times, between 1:0.7 to 1:1.3; at times, between 1:0.8 to 1:1.1, and further at times, between 1:1 to 1:1.3.

In some examples, the % wt ratio between the catalytic entities, namely, Pd and said Fe (in the Fe species) is about 1:1.

In some examples, the bimetallic catalyst can be defined by the % wt of each of catalytic entities, i.e. Pd and Fe species out of the total weight of the catalyst.

In some examples, the carrier comprises between about 0.5-1.5% wt of Pd out of the total weight of the bimetallic catalyst, at times between about 0.75-1.5%, at times between about 0.9-1.5%, at times between about 1-1.5%; at times between about 0.5-1.1% wt, at times between about 0.5-1.2% wt, at times between about 0.5-1.3% wt, 0.5-1.4% wt, at times at times between about 0.6-1.1% wt, at times between about 0.6-1.2% wt, at times between about 0.6-1.3% wt, at times between about 0.6-1.4% wt, at times between about 0.6-1.5%, at times at times between about 0.7-1.1% wt, at times between about 0.8-1.2% wt, at times between about 0.9-1.3% wt, at times between about 1.0-1.4% wt.

In some examples, the carrier comprises between about 0.5-1.5% wt of Fe species out of the total weight of the bimetallic catalyst, at times between about 0.75-1.5%, at times between about 0.9-1.5%, at times between about 1-1.5%; at times between about 0.3-1.1% wt, at times between about 0.3-1.2% wt, at times between about 0.3-1.3% wt, at times between about 0.3-1.4% wt, at times between about 0.4-1.1% wt, at times between about 0.4-1.2% wt, at times between about 0.4-1.3% wt, at times between about 0.4-1.4% wt, at times between about 0.5-1.1% at times between about wt, at times between about 0.5-1.2% wt, at times between about 0.5-1.3% wt, at times between about 0.5-1.4% wt, at times between about 0.6-1.1% wt, at times between about 0.6-1.2% wt, at times between about 0.6-1.3% wt, at times between about 0.6-1.4% wt, at times between about 0.6-1.5%, at times between about 0.7-1.1% wt, at times between about 0.8-1.2% wt, at times between about 0.9-1.3% wt, at times between about 1.0-1.4% wt.

As noted above, the bimetallic catalyst comprises a carrier holding the combination of Pd and Fe species. In some examples, the carrier is an activated carrier. The activated carrier can be activated carbon, e.g. granular, fibrous, woven or non-woven activated carbon. In some examples, the activated carbon is activated carbon fibrous fabric (ACFF).

In some examples, the activated carrier is activated alumina (AA).

In some examples, the carrier is ACFF and it supports about 1% wt Pd and about 1% wt Fe species. In some examples, the ACFF supports a mass ratio between Pd and Fe species of about 1:1.

In some examples, the catalytic entities are supported at least on the surface of the carrier, e.g. on the surface of the ACFF.

In some examples, the carrier is ACFF and the process comprises passing the water containing the selenate through the ACFF supporting the bimetallic catalyst.

In some examples, the carrier is a particulate matter.

In some other embodiments, the carrier is in the form of a sheet, e.g. textile cloth or fabric.

In some examples, the carrier carries about 1% wt Pd and about 1% wt iron species out of the total weight of the catalyst.

In some examples, the catalytic entities are at least on the surface of the carrier. In some examples, the carrier has a surface area of at least 500 m²/g, at times, at least 800 m².

The water to be treated (for reducing selenate) is then brought into contact with the bimetallic catalyst described herein. The contacting may be in any form including flowing thought, flowing over, e.g. in a laminar flow over bimetallic catalyst, suspending the bimetallic catalyst in the reactor (e.g. in the form of particulate matter), or any other physical form of providing sufficient proximity between the water and the catalyst, as known to those versed in the art.

In some examples, the contacting of water with the bimetallic catalyst is within a reactor comprising or holding the bimetallic catalyst. The reactor may be of any form or configuration allowing the water to come into contact with the bimetallic catalyst under conditions sufficient to facilitate the reduction of selenate to selenite in the presence of hydrogen. The reactor thus is configured to facilitate introduction of hydrogen into the water to be treated (for reducing at least selenate to selenite).

In some examples, the operation of the reactor is controlled by terms of temperature of the water while in contact with the bimetallic catalyst. In some examples, the temperature is controlled to be maintained within a range of between 1° C. to 60° C. In some other examples, the temperature is controlled to be maintained in the range of between 1° C. to 55° C., at times in the range of between about 1° C. to 50° C.; at times in the range of between about 1° C. to 45° C.; at times in the range of between about 1° C. to 40° C.; at times in the range of between about 1° C. to 35° C.; at times in the range of between about 1° C. to 30° C.; at times in the range of between about 10° C. to 25° C. In some examples, the temperature is controlled to be maintained within a range of between 10° C. to 70° C. In some other examples, the temperature is controlled to be maintained in the range of between 10° C. to 50° C., at times in the range of between about 10° C. to 40° C.; at times in the range of between about 10° C. to 30° C.; at times in the range of between about 15° C. to 40° C.; at times in the range of between about 15° C. to 35° C.; at times in the range of between about 15° C. to 30° C. At times, the temperature is controlled to be maintained at room temperature.

In some examples, the operation of the reactor is controlled by terms of flow rate of the water therein. The reactor is operated such that the water to be treated flows through or over the bimetallic catalyst at a flow rate that provides the bimetallic catalyst with sufficient time to enhance the reducing hydrogenation by the dissolved hydrogen. The flow rate may depend on various parameters, including the temperature of the water to be treated, the concentration of the catalyst, the pH of the water, etc. In some examples, the water flows in the reactor at a flow rate of between 0.4 to 1.0 liter/hour, at times, at a flow rate between 0.6 to 0.8 liter/hour, at times between 0.5 to 0.9 liter/hour, at times between 0.5 to 1 liter/hour.

In some examples, the reactor is a radial flow reactor enclosing the bimetallic catalyst, through which water to be treated flows.

In the context of the present disclosure it is to be understood that the bimetallic catalyst enhances/catalyses the rate of conversion of selenate to selenite without itself undergoing any permanent chemical change. In other words, the bimetallic catalyst is not reacted (or does not act as a reactant) in the reduction process.

The process disclosed herein is effective to decrease the level of selenate (dissolved ions) in the water to 50 ppb. At times, the process is effective to decrease the level of dissolved selenate ions to below 50 ppb; at times, to below 45 ppb; at times, to below 40 ppb; at times, to below 35 ppb; at times, to below 30 ppb; at times, to below 25 ppb; at times, to below 20 ppb; at times, to below l0 ppb; at times, to below 5 ppb; at times, to below 1 ppb or even to below 0.5 ppb.

The conversion of selenate to selenite results in water containing or enriched with selenite. Such water may be subjected to further processing, e.g. in order to remove any selenium species from the water. In this context, selenium species refer to any form of dissolved selenium. In this connection it is noted that selenium exists in water as highly soluble oxyanions, e.g. selenate but also selenite.

The process disclosed herein may be utilized for treating water, to remove therefrom any selenium species. The water to be treated may be of any source. In some examples, the water is wastewater from industries wastewater. In some other examples, the water is sewer water including domestic, municipal or industrial liquid waste. In some other examples, the water is contaminated by selenium from discharge from petroleum and metal refineries and/or discharge from mines. In some other examples, the water is contaminated from erosion of natural deposits.

Water to be treated according to the present disclosure is defined as one comprising a level of contaminants (physical, chemical, biological or radiological substances or matter in water) above the Maximum Contaminant Level (MCL). With respect to selenium, the MCL is 0.05 mg/L or 50 ppb.

Treatment of water in order to remove any selenium species can thus include further steps. Thus, the present disclosure also provides a process for treating water (to at least reduce therein level of selenium species). The process comprises converting selenate to selenite in the process as described hereinabove to obtain selenite containing water.

When referring to selenite containing water it is to be understood as meaning water containing elevated levels of selenite, at least above the acceptable standard of 50 ppb. At times, the level of selenite after treatment with the bimetallic catalyst is at least twice the level thereof before said treatment. At times, the level of selenite is at least trice, or event more the level therefore before said treatment.

The water being enriched with the selenite is then subjected to at least one additional catalytic reaction in order to convert selenite to elemental selenium, by a further reducing reaction in the presence of hydrogen.

Without being bound by theory, the second reduction stage involves the following reaction scheme (B):

2SeO₃²⁻+6H₂→2Se⁰+3/2H₂O+3OH⁻ (B)

The selenium (Se⁰) thus formed then coagulates and deposits to an extent that it can be easily removed.

In some examples, the second reducing stage takes place in the presence of a catalyst. In some examples, the second catalyst is Pd catalyst and the process is under hydrogen environment.

The formed selenium is then removed by any means of removing solids from liquid, including, for example, filtration.

The water, after removal of the coagulated selenium can be regarded as selenium free water. In this context, the term “selenium free water” is to be understood as water containing less than 50 ppm selenium species (including dissolved ion and/or elemental selenium). At times, the selenium free water refers to water containing less than 30 ppm, or even less than 20 ppm selenium species.

In some examples, the processes disclosed herein, either for reducing selenate to selenite, or the process for treating water to reduce selenium species, is a continuous process. In some other examples, the processes are batch processes.

The present disclosure also provides a bimetallic catalyst comprising, supported on a carrier, a combination of Pd with an iron species, the latter being as defined herein.

In some examples, the bimetallic catalyst can be for use in a process for converting selenate in water to selenite.

In some other examples, the bimetallic catalyst is for use in a process for treating water.

### DETAILS OF SOME NON-LIMITING EXAMPLES

### Preparation and Characterization of Metal Supported ACFF Catalysts

### Catalyst Support

Activated carbon fiber fabric (ACFF from Taiwan Carbon Technology) woven from activated carbon fiber was employed in Examples 1-11 (shown in Table 1) as a catalyst carrier.

The basic characteristics of ACFF are the following: 8-10 μm in diameter, BET surface area 980±50 m²/g; the micropore volume 0.22 cm³/g, and average pore diameter of 4.6 nm. The specific surface area of ACFF was measured by BET process using N₂ adsorption-desorption at −196° C. via an Accelerated Surface Area and Porosimetry System Micromeritics (ASAP 2010).

Before deposition of the bimetallic catalyst on the carrier, the ACFF carrier was thoroughly rinsed with deionized water to remove carbon dust and then treated with 10% solution of H₂O₂ at 50-60° C. for 1 hour followed by additional water rinsing.

### Example 1

### Pd/ACFF-Supported Catalyst Preparation

Pd/ACFF was prepared by incipient wetness impregnation of ACFF with an aqueous solutions of sodium tetrachloropalladate (II) (Na₂PdCl₄, obtained by dissolution of solid PdCl₂ salt in sodium chloride solution) of appropriate concentration. The volume of impregnation solution was 0.33 ml per g ACFF, which represented 10 percent excess with respect to the pore volume of the ACFF. The impregnated ACFF sample was left 6 h at room temperature, dried during 8 h at 85° C. and then reduced with sodium borohydride at 20° C. for 1 h under a flow of hydrogen.

### Example 2

### Ru/ACFF-Supported Catalyst Preparation

Ru was deposited onto catalyst carrier by incipient wetness impregnation with aqueous solutions of ruthenium trichloride (obtained by dissolution of solid RuCl₃ 9H₂O salt in deionized water) of appropriate concentration. The volume of impregnation solution was 0.33 ml per g of the ACFF. The impregnated ACFF sample was left for 6 h at room temperature, dried at 85° C. for 8 h and then reduced with solution of sodium borohydride at 20° C. for 1 h under a flow of nitrogen.

### Example 3

### Fe/ACFF-Supported Catalyst Preparation

Fe was deposited onto catalyst support by incipient wetness impregnation with solutions of Fe(NO₃)₂ 9H₂O salt in deionized water of appropriate concentration. The volume of impregnation solution was 0.33 ml per g of the ACFF. The impregnated ACFF was left for 6 h at room temperature, dried at 85° C. for 8 h and then reduced by solution of sodium borohydride at 20° C. for 1 h under a flow of nitrogen.

### Example 4

### FeₓO_{y}/ACFF-Supported Catalyst Preparation

The catalyst carrier was impregnated with aqueous solutions of Fe(NO₃)₂ 9H₂O as described in Example 3 and after drying at 85° C. for 8 h was immersed in 0.1M solution of NaOH for 4 h, according to reaction (C):

Fe(NO₃)₂+2Na(OH)→Fe(OH)₂+2Na⁺+2NO₃⁻ (C)

During further calcination at 250° C. in flowing nitrogen for 2 h, the ferric hydroxide is transferred into a mixture of ferric and ferrous oxides (denotes further as FeₓO_{y}, where x=1-2 and y=1-4):

Fe(OH)₂→FeₓO_{y} (D)

### Example 5

### Bimetallic PdFe/ACFF-Supported Catalyst Preparation

The monometallic Pd catalyst prepared as described in Example 1, was impregnated with aqueous solutions of Fe(NO₃)₂ as described in Example 3. The impregnated ACFF sample was dried and then reduced with solution of sodium borohydride as described in Example 3.

### Example 6

### Bimetallic RuFe/ACFF-Supported Catalyst Preparation

The monometallic Ru catalyst prepared as described in Example 2 was impregnated with aqueous solutions of Fe(NO₃)₂ 9H₂O as described in Example 3. The impregnated ACFF sample was dried and then reduced with solution of sodium borohydride as described in Example 3.

### Example 7

### Bimetallic PdCu/ACFF-Supported Catalyst Preparation

The monometallic Pd catalyst prepared as described in Example 1 was immersed into solution of copper formate Cu(HCO₂)₂ under flowing nitrogen gas. The copper formate catalytically decomposes at the surface of Pd particles at room temperature, generating metallic copper, according reaction (E):

Cu(HCO₂)₂→Cu+2CO₂+H₂O (E)

### Example 8

### Bimetallic Pd-FeₓO_{y}/ACFF-Supported Catalyst Preparation

The monometallic Pd catalyst prepared as described in Example 1 was impregnated with aqueous solutions of Fe(NO₃)₂ 9H₂O as described in Example 3 and after drying at 85° C. for 8 h was immersed in 0.1M solution of NaOH for 4 h. Then solid was separated from liquid and heated at 250° C. in flowing nitrogen for 2 h.

### Example 9

### Bimetallic Ru—FeₓO_{y}/ACFF-Supported Catalyst Preparation

The monometallic Ru catalyst prepared as described in Example 2 was impregnated with aqueous solutions of Fe(NO₃)₂ 9H₂O as described in Example 3 and after drying at 85° C. for 8 h was immersed in 0.1M solution of NaOH for 4 h. Then solid was separated from liquid and heated at 250° C. in flowing nitrogen for 2 h.

### Example 10

### Tri-Metallic PdCuFe/ACFF-Supported Catalyst Preparation

The bimetallic PdCu catalyst prepared as described in Example 7 was impregnated with aqueous solutions of Fe(NO₃)₂ 9H₂O as described in Example 3. The impregnated ACFF sample was dried and then reduced with solution of sodium borohydride as described in Example 3.

### Example 11

### Tri-Metallic PdCuFeₓO_{y}/ACFF-Supported Catalyst Preparation

The bimetallic PdCu catalyst prepared as described in Example 7 was impregnated with aqueous solutions of Fe(NO₃)₂ 9H₂O and after drying at 85° C. for 8 h was immersed in 0.1M solution of NaOH for 4 h. Then solid was separated from liquid and heated at 250° C. in flowing nitrogen for 2 h.

The content in wt % of each of the components comprising the catalysts, according to the above Examples 1-11, are provided in Table 1.

TABLE 1
Characteristics of Examples 1-11 comprising
ACFF-supported catalyst

| | | | Fe°, | Cu°, | FeₓO_{y}, |
|---|---|---|---|---|---|
| Example No | Cat/support | wt % | wt % | wt % | wt % |
| 1 | Pd°/ | 1.0 | | | |
| 2 | Ru°/ | 1.0 | | | |
| 3 | Fe°/ | | 1.0 | | |
| 4 | FeO/ | | | | 1.29 |
| 5 | Pd°—Fe° | 1.0 | 1.0 | | |
| 6 | Ru°—Fe°/ | 1.0 | 1.0 | | |
| 7 | Pd°—Cu°/ | 1.0 | | 0.37 | |
| 8 | Pd° FeₓO_{y}/ | 1.0 | | | 1.29 |
| 9 | Ru°—FeₓO_{y}/ | 1.0 | | | 1.29 |
| 10 | /Pd°—Cu°—Fe°/ | 1.0 | 1.0 | 0.37 | |
| 11 | Pd°—Cu°—FeₓO_{y}/ | 1.0 | | 0.37 | 1.29 |

### Determination of Catalytic Activity for Selenate Hydrogenation of Examples 1-11

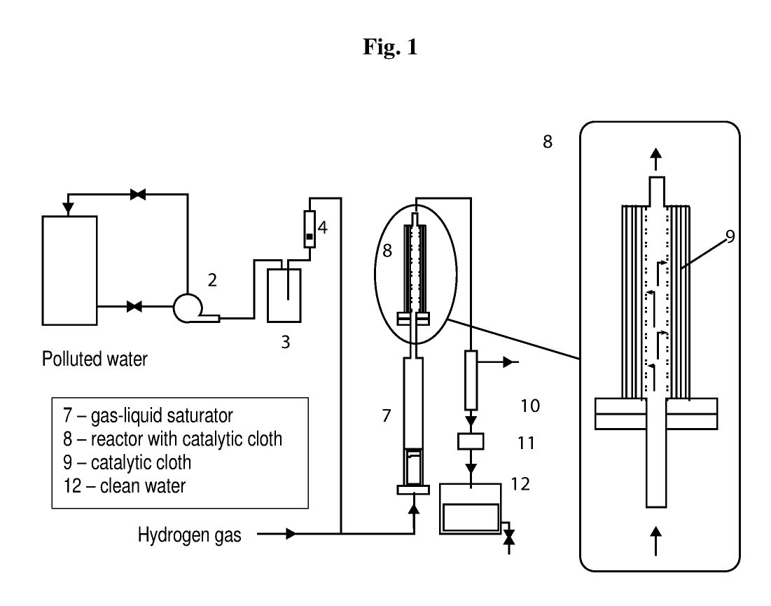

The catalysts supported ACFF of Examples 1-11 were each introduced into a mini-pilot radial flow reactor according to FIG. 1.

In the presence of hydrogen, participating as a reducing agent, selenate is converted to selenite by hydrogenation according to aforementioned reaction (A).

In a typical run of each catalyst supported ACFF sample, a solution of sodium selenate Na₂SeO₄ in deionized water (0.5-30 ppm, pH 6.8-7.0) was fed at a flow rate of 0.6 L/h at room temperature through gas-water saturator, in which hydrogen gas was pre-dissolved in nitrate solution under pressure (6 bar) and controlled ambient temperature and further entered into the radial-flow catalytic reactor in which the fabric supported catalyst was spirally wound around the central cylinder. The total mass (weight) of the catalyst in the reactor was 13-18 g.

To measure concentration of selenite in water, samples of effluent water were taken every 1 hour. In each sample, the selenite formed during reduction process was separated by co-precipitation of MgSeO₃ with Mg(NO₃)₂ and NaOH (M. Tuzen, K. O. Saygi, M. Soylak, Talanta 71 (2007) 424-429) with the relative error between 6-10%. Then the concentration of selenate in each of the filtered samples was measured with ICP-OES Spectrophotometer (Inductively Coupled Plasma—Optical Emission Spectrometry, iCAP 6000 series Thermo Scientific).

### Characterization of the ACFF-Supported Samples

### Catalyst Activity

The activity of the tested samples in the reduction of selenate was calculated according to the following equation:

A=(Cᵢₙ−Cₒᵤₜ)*F/W_{cat} (F)

where

Cᵢₙ is the concentration of selenate before treatment in the reactor [μmol/L];

Cₒᵤₜ is the concentration of selenate after treatment in the reactor [μmol/L];

F represents liquid flow rate [L/h]; and

W_{cat} represents the weight of catalyst in the reactor [g].

The rate of selenite reduction according to aforementioned reaction (A) depends on the initial selenate concentration. Thus, the activity was normalized to initial selenate concentration according to equation (G):

A_{N}=A/Cᵢₙ (G)

where

A_{N} is the normalized to influent selenate concentration in L per hour per gram catalyst (i.e., in L/h⁻¹ g_{catalyst}⁻¹).

### Results

The initial selenate concentration in the tested water and at a temperature of 23° C. and reactor pressure of 5 bar was 0.5-27 mg/L. Table 2 provides the experimental results of the concentration of selenate before and after treatment and the calculated activity and normalized activity for each catalyst sample according to Examples 1-11.

TABLE 2
Concentration of selenate before and after treatment; activity (A) and
normalized activity (A_{N}) of catalyst samples according to Examples 1-11.

| Example | | | Cᵢₙ, | Cₒᵤₜ, | Cᵢₙ − Cₒᵤₜ, | A, | A_{N} |
|---|---|---|---|---|---|---|---|
| No | Cat/ACFF | W_{cat}, g | μmol/L | μmol/L | μmol/L | μmol/h g | L/h g_{cat} |
| — | /ACFF | 17 | 172.0 | 172.0 | 0 | 0 | 0 |
| 1 | 1% Pd | 16 | 37 | 31.26 | 0.3 | 0.01 | 0.0003 |
| 2 | 1% Ru | 18 | 170 | 139.2 | 31.0 | 0.22 | 0.0013 |
| 3 | 1% Fe | 18 | 172.0 | 172.0 | 0 | 0 | 0 |
| 4 | 1.29% FeₓO_{y} | 18 | 172.0 | 172.0 | 0 | 0 | 0 |
| 5 | 1% Pd1% Fe | 13 | 4 | 0.70 | 3.0 | 0.14 | 0.0338 |
| 6 | 1% Ru1% Fe | 17 | 172 | 116.1 | 32.9 | 1.16 | 0.0067 |
| 7 | 1% Pd0.36% Cu | 18.8 | 172 | 146.4 | 0.2 | 0.01 | 0.0000 |
| 8 | 1% Pd1.29% FeₓO_{y} | 13 | 4 | 0.01 | 3.7 | 0.17 | 0.0423 |
| 9 | 1% Ru1.29% FeₓO_{y} | 17 | 172 | 96.50 | 54.0 | 1.91 | 0.0110 |
| 10 | 1% Pd0.36Cu1% Fe | 18.8 | 172 | 145.45 | 1.8 | 0.06 | 0.0003 |
| 11 | 1% Pd0.36% Cu1% FeₓO_{y} | 18.8 | 172 | 146.3 | 0.3 | 0.01 | 0.0000 |

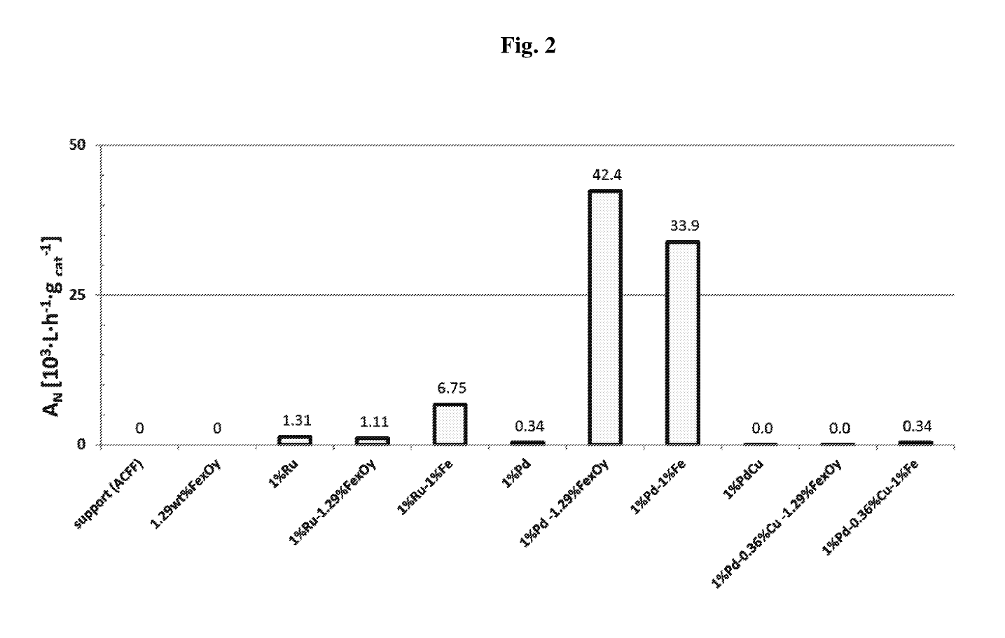

The results of the activity displayed in Table 2 are also presented in FIG. 2. As may be exhibited from Table 2 and FIG. 2, both Pd/Fe and Pd/FeₓO_{y} catalysts (Examples 5 and 8 in Table 2) are significantly more active than other catalyst samples tested.

As may further be exhibited from the comparison of activity of the examples displayed in Table 2 and FIG. 2, the activity of the bimetallic catalyst Pd/FeₓO_{y} (1% wt:1.29% wt, Example 8) is greater than the sum of activity of carrying only FeₓO_{y} (1.29% wt, Example 4) or only ACFF carrying only Pd (1% wt, Example 1).

1. A process for converting selenate to selenite, the process comprises contacting water containing selenate, under hydrogen environment, with a bimetallic catalyst comprising, supported on a carrier, a combination of Pd and Fe species, wherein said contacting with the bimetallic catalyst results in the reduction of selenate to selenite.

2. The process of claim 1, wherein said Fe species is selected from the group consisting of metallic Fe, iron oxide and any combination of same.

3. The process of claim 2, wherein said iron oxide has the general formula FeₙOₘ with n being an integer of 1 to 3 and m being an integer of 1 to 4.

4. The process of claim 2, wherein said Fe species is selected from the group consisting of Fe, FeO and Fe₂O₃.

5-6. (canceled)

7. The process of claim 1, wherein the mass ratio between said Pd and said Fe in said Fe species is between 1:0.2 to 1:3, between about 1:1 to 1:1.3 or about 1:1.

8-9. (canceled)

10. The process of claim 1, wherein said hydrogen environment is provided by introducing hydrogen gas into water under a pressure of between 4 to 10 bar or by dissolving hydrogen gas within the water.

11-12. (canceled)

13. The process of claim 1 comprising flowing the water containing selenate through a reactor comprising the bimetallic catalyst in a flow rate of between about 0.4 to 1.0 liter/hour, wherein said reactor may be a radial flow reactor.

14-15. (canceled)

16. The process of claim 1 comprising controlling temperature upon contact of said water with the bimetallic catalyst to be between 10° C. to 40° C.

17. The process of claim 1, wherein said carrier comprises activated carbon fibrous fabric (ACFF) and said process comprises passing the water through the bimetallic catalyst supported on said ACFF.

18. The process of claim 17, wherein said bimetallic catalyst is supported at least on the surface of the ACFF.

19. The process of claim 1, wherein said ACFF carries about 1% wt Pd and about 1% wt iron species out of the total weight of the bimetallic catalyst.

20. The process of claim 1, wherein said carrier comprises particulate matter and said bimetallic catalyst is supported at least on the surface of the particulate matter.

21. The process of claim 1, wherein said carrier has a surface area larger than 500 m²/g.

22. (canceled)

23. The process of claim 1, for reducing level of dissolved selenate to be equal or less than 50 ppb.

24-26. (canceled)

27. A process for treating water comprising:
(a) converting selenate to selenite according to the process of claim 1 to obtain selenite containing water;
(b) contacting the selenite containing water with a second catalyst capable of reducing selenite to selenium; and
(c) removing said selenium from the water.

28. The process of claim 27, wherein said second catalyst is Pd.

29. The process of claim 27, wherein said selenium is removed by filtration.

30-36. (canceled)
